(19) United States
(12) Patent Application Publication
(10) Pub. No.: US 2005/0184203 A1
(43) Pub. Date: Aug. 25, 2005

(54) Hose holder

(76) Inventor: Edward A. Votypka, Chagrin Falls, OH (US)

Correspondence Address: D.A. STAUFFER PATENT SERVICES LLC, 1006 MONTFORD ROAD, CLEVLAND HTS., OH, 44121-2016, US

(21) Appl. No.: 10/944,212

(22) Filed: Sep. 17, 2004

Related U.S. Application Data
(60) Provisional application No. 60/547,692, filed on Feb. 25, 2004.

(51) Int. Cl. B05B 15/06

(52) U.S. Cl. 248/87

(57) ABSTRACT

A hose holder and a method for adjusting the spray direction of a hose in a hose holder. The holder has a longitudinally extending trough attached at a fixed elevational angle to a laterally extending socket that is designed to be used in cooperation with a removably matingly shaped peg that can be mounted on any suitable support structure. A multi-point socket hole with a regular polygonal cross section removably mates with a square peg for providing selectable horizontal angular positioning. The trough partially encircles the hose to keep it substantially straight, and resilient end clips further encircle the hose to removably hold it. An upward or downward directed elevational angle for the spray direction is selected by engaging the hose in the holder with an open end at an upper or lower end of the trough. One or more variable height ground engaging supports provide height and location adjustment.

### CROSS-REFERENCE TO RELATED APPLICATIONS

This application relates to US Design Patent Application entitled HOSE HOLDER, Attorney's Docket No. EV-102, filed Feb. 7, 2004 by Edward A. Votypka.

This application claims the benefit of U.S. Provisional Patent Application No. 60/547,692, filed Feb. 25, 2004 by Edward A. Votypka.

### TECHNICAL FIELD OF THE INVENTION

The present invention relates to supports for hoses and, more particularly to hose holders for directional control of water being sprayed from the hose to water yards and gardens.

### BACKGROUND OF THE INVENTION

Flexible hoses with spray nozzles are commonly used for watering yards and gardens, and a variety of devices have been created for holding the hose in a fixed position in order to direct the spray in a predetermined direction for a length of time, thereby relieving a user from the task of standing and holding the hose by hand. A simple hose holder is illustrated in the US Design Patent No. Des. 263,903 (Johnston; 1982). This hose holder apparently must be pulled out of the ground and pushed back in again in order to adjust the direction of spray for a hose clipped into the holder. Often, users desire a way to more easily adjust horizontal and/or elevational (vertical) angles for the spraying direction.

U.S. Pat. No. 2,425,893 (Molitor) discloses a garden hose holder wherein 2 or 3 twisted wires form a prong topped with spaced apart S-shaped open loops opening opposite to each other for releasably holding the hose. The prong can be rotated in the ground for horizontal angle adjustment, but must be removed and replaced for elevational angle adjustment. It is apparent that this is still rather inconvenient, and that the hose resting on the ground must apparently be relied upon to maintain a given horizontal adjustment angle. Furthermore, a wire stake would not be strong enough to hold the hose at significantly elevated heights above the ground. It should also be noted that Molitor's garden hose holder holds the hose in a way that does not provide support for the hose in between the spaced apart loops.

A number of prior art devices provide somewhat more convenient horizontal and/or vertical spray angle adjustment through the use of set screws or wing nuts on bolts, but all suffer from obvious defects such as the inconvenience of loosening and tightening screws and nuts, or such as the effects of rust on such parts. U.S. Pat. No. 2,942,822 (Crow; 1960) discloses a holder wherein a wing nut (33) controls the elevational angle, but a rod (10) with a tang (13) controls the horizontal angle, requiring pulling out the rod and pressing it back into the ground for horizontal adjustment. The same wing nut (33) must be loosened in order to release a hose held in a sheet metal trough (22) by a clamping wire (25). U.S. Pat. No. 3,119,587 (Anderson; 1964) discloses a hose holding fixture that also uses a wing nut (26) for elevational angle adjustment. The fixture has a short flat surface with rigid hooks (16) on either end having opposed openings. U.S. Pat. No. 2,495,995 (Warrens, et al.; 1948) discloses a standard (1) on a four-legged stand (feet 2, 3), and a ball (13) in socket (10) arrangement for universal angular adjustment, tightened by a wing nut (12). Hose holding is by means of two outward-opening spring clips (15) spaced apart on a flat bracket member (14).

U.S. Pat. No. 2,993,671 (Knebusch; 1961) discloses a garden hose stand, angularly adjustable for both horizontal traverse and vertical elevational angles. The elevational angle is controlled by a wing nut (42) on a pivot screw plus detent serrations (41) that mate with a rivet head (36). A round support rod (20) has flanges (24) to prevent turning in the ground. The holder is mounted on the rod by a round socket-hole (32) in a post (30) that fits over the top of the round rod, and rotational positioning is achieved by loosening and retightening a thumb screw (33). A hose (13) is clamped between two sheet metal pieces (55, 56) pressured by a wing nut (61).

U.S. Pat. No. 2,711,927 (Miller, et al.; 1952) discloses a lawn sprinkler comprising a built-in nozzle (sprinkler head 18) attached on top of a round post (10) emanating from a stirrup on top of a flanged spike for implanting in the ground in a way that won't rotate. A friction block (44) bearing on a pivoting lug (40) of the nozzle holds a desired elevational angle. Since the nozzle and vertical adjustment assembly is secured on the post (10) by welding or a set screw, horizontal adjustment is apparently accomplished by unplanting, rotating, and replanting in the ground. In order to remove a hose (50) from the sprinkler, it must be unscrewed from the nozzle.

Two patents disclose the use of vertical notches in a tube for horizontal adjustment of a nozzle.

U.S. Pat. No. 3,599,917 (Schwartz; 1969) discloses a hose nozzle support standard that provides a wire (46) formed into a hook (48) for releasable hose holding wherein the hook fits into a circumferential groove (54) in the hose nozzle (50). The wire (46) has a straight shank (44) that passes diametrically through the top of a tubular support member (40) that telescopes over a support standard post (12), also hollow tubular. At the top of the post (12) are twelve upwardly opening notches (36, 38) having two different notch depths that alternate around the circumference of the top of the post. Under the weight of the hose and member (40), the shank (44) is keyed to a selected notch (36, 38) to hold the selected horizontal rotational angle. Vertical angle adjustment is not addressed.

U.S. Pat. No. 936,769 (Flower) discloses a blowpipe on a stand wherein a hollow cylindrical shell (D) fits over and rests upon a post (B). The shell (D) has a series of downwardly opening notches (E) that engage with a lug (F) on the post such that the weight of the blowpipe holds the shell in engagement at a selected horizontal rotational angle. A biased-open spring latch (G, G1, G2) can be pressed to temporarily connect the shell and post so that the blowpipe with stand can be moved together. A thumbscrew (K) is used to set and hold a vertical angle adjustment.

The abovedescribed prior art references additionally disclose various means for holding the hose. US Design Patent No. Des. 408,269 (Ross; 1999) discloses a hose holder comprising a flat strip with 3 U-shaped clips in line, having alternating-sided openings. A hook at the end of the strip is presumably for hanging the hose.

The abovedescribed prior art references additionally disclose various means for supporting the hose holding portion above the ground. The following patent discloses a device for adjusting the vertical height, but not the elevational angle and neither does it accommodate controlled horizontal angular adjustment. It appears to be intended for use with vertical sprinkler heads (11) with water control valves (10). U.S. Pat. No. 4,850,555 (Lemkin, et al.; 1989) discloses a stake and coupling system for holding an irrigation device at an adjustable height determined by the number of stake portions (1) that are coupled together. Each stake (1) has a multilobed cross-section coming to a point (4) at one end, for anchoring in the ground, and having a central round projection (3) at the other end, for mounting the irrigation device (9). A coupler (16) is a hollow multilobed construction that receives either the round projection (3) or the pointed end (4), and holds the parts together in a firm but resilient gripping action.

It is an object of the present invention to provide an improved hose support including convenient means for regulating the direction of the spray both horizontally and vertically, while overcoming the limitations and deficiencies of prior art hose holders. Prior art hose holders are not stable during use and/or lack ease of use for directing a stream or spray without considerable machinations involving, for example, complete removal from the ground and then repositioning, or manipulation of a locking or screw-like device in order to accomplish the vertical and/or horizontal angular positioning.

It is an object of this invention to releasably hold the hose in a way that supports the hose sufficiently to prevent squirming and otherwise shifting of the hose position, while at the same time enabling the hose to be easily engaged and disengaged from the hose holder, even while the hose is in spraying operation.

It is an object of this invention for the hose holder to be easily separable from a supporting post, and also for the hose holder to be compactly and simply constructed (preferably in a single piece) such that the hose holder can be left on the hose, thereby allowing one or more supporting posts to be left in the ground at various convenient watering locations while the hose with attached hose holder is removed from the lawn or is moved from one post to another.

It is an object of this invention to provide a hose holder that may be quickly and easily rotated to change the horizontal angular direction of the spray issuing from the hose, even while the hose remains in spraying operation. A further object is to have the hose holder maintain a stable stationary hose (and nozzle) position relative to upward/downward (vertical) angular, horizontal rotational angular, or linear vertical height movement, while the hose is in spraying operation.

It is an object of the invention to provide a hose holder that is durable, compact, rugged, convenient and easy to use.

### BRIEF SUMMARY OF THE INVENTION

According to the invention, a hose holder comprises: a longitudinally extending trough for holding a hose; and a socket with a multi-point socket hole, wherein the socket extends laterally from a bottom of the trough.

According to the invention, the hose holder further comprises a peg shaped for adjustable mating with the socket. Preferably the peg projects approximately upward from a ground engaging support structure. Also preferably, the socket hole and the peg have regular polygonal cross-sections. Most preferably the socket hole has twelve points; and the peg has four points.

According to the invention, the hose holder is such that the trough is attached at a fixed elevational angle to the socket, wherein the elevational angle is measured between a baseline that is perpendicular to a socket axis, and a longitudinally extending trough line. Preferably the elevational angle is in the range of approximately 0 degrees to approximately 30 degrees.

According to the invention, the hose holder further comprises: a partially circular cross-sectional shape for the trough; a longitudinally extending first trough edge at a first trough edge extent angle measured in a first direction from the trough bottom; and a longitudinally extending second trough edge at a second trough edge extent angle measured in a second direction, opposite to the first direction, from the trough bottom. Preferably the first trough edge extent angle is approximately equal to the second trough edge extent angle; and each of the first and second trough edge extent angles is within the range of approximately 40 degrees to approximately 100 degrees. Also preferably, the sum of the first trough edge extent angle and the second trough edge extent angle is within the range of approximately 240 degrees to 280 degrees. Also preferably, the hose holder further comprises: a first end clip circling upward from the trough bottom, continuing the same circular contour as the trough, to a first clip edge protruding from a first one of the first and second trough edges, and extending longitudinally along a first portion of a trough length; and a second end clip circling upward from the trough bottom, continuing the same circular contour as the trough, to a second clip edge protruding from a second one of the first and second trough edges, and extending longitudinally along a second portion of the trough length. Further preferably, the first one trough edge is different than the second one trough edge; and the first portion of the trough length and the second portion of the trough length are at opposed longitudinal ends of the trough. Further preferably, each of the first and second trough edge extent angles is within the range of approximately 40 degrees to approximately 100 degrees; and an opening angle, measured across open space between the first clip edge and its opposed trough edge is approximately equal to an opening angle measured across open space between the second clip edge and its opposed trough edge, and has a magnitude in the range of approximately 80 degrees to 120 degrees.

According to the invention, the hose holder further comprises a longitudinally extending groove in the bottom of the trough.

According to the invention, the hose holder further comprises single piece construction molded out of a resilient material.

According to the invention, the hose holder further comprises a web extending between the socket and the trough.

According to the invention, a method for adjusting the spray direction of a hose in a hose holder, comprises the steps of: providing a removably matingly shaped socket and peg; designating a one of the socket and peg as a first joint and the other one of the socket and peg as a second joint; attaching the first joint to the holder as a lateral extension of the holder relative to the longitudinally extending hose in the holder; attaching the second joint as an approximately vertical extension of a ground engaging support structure; and adjusting a horizontal angular position of the holder by un-mating the first joint and the second joint; followed by rotating the holder to a new selected horizontal angle, followed by mating the first joint and the second joint at the new selected horizontal angle.

According to the invention, the method further comprises the steps of: attaching the first joint to the holder at a fixed elevational angle, wherein the elevational angle is measured between a baseline that is perpendicular to a first joint axis, and a longitudinally extending line of the hose in the holder; removably engaging the hose in the holder; and adjusting an elevational angular position of the hose by selecting an upward directed elevational angle or a downward directed elevational angle, wherein: the upward directed elevational angle is selected by engaging the hose in the holder such that a spraying end of the hose is adjacent to an upper end of the holder; and the downward directed elevational angle is selected by engaging the hose in the holder such that the spraying end of the hose is adjacent to a lower end of the holder.

According to the invention, the method further comprises the step of adjusting a height of the holder above the ground by adjusting a height of the ground engaging support structure.

According to the invention, the method further comprises the step of holding the hose in a substantially linear configuration in the holder by providing a longitudinally extending trough in the holder, the trough having a partially circular cross-sectional shape dimensioned for partially encircling the hose.

According to the invention, the method further comprises the steps of: providing one or more support structures that are engaged in the ground such that a plurality of second joints are positioned at a plurality of horizontal locations; and adjusting a horizontal location of the hose by selecting a one of the plurality of second joints, and engaging the first joint with the selected one of the plurality of second joints.

According to the invention, the method further comprises the steps of: dividing the support structure into a plurality of sections, including a ground engaging section and at least one non-ground-engaging section, wherein each non-ground-engaging section has a copy of the peg on one end, and a variant of the socket on an opposed end; such that the variant of the socket has a different number of points than the socket; and providing smaller increments for horizontal angular position adjustment by horizontally rotating one of the at least one non-ground-engaging sections relative to the ground engaging section, in combination with horizontally rotating the holder relative to the one of the at least one non-ground-engaging sections.

Other objects, features and advantages of the invention will become apparent in light of the following description thereof

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of similar elements collectively referred to as 199 may be referred to individually as 199a, 199b, 199c, etc. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a side perspective view of a hose holder, according to the invention;

FIG. 2 is an end view of the hose holder of FIG. 1, according to the invention;

FIG. 3 is a side view of the hose holder of FIG. 1, according to the invention;

FIG. 4 is a top view of the hose holder of FIG. 1, according to the invention;

FIG. 5 is a bottom view of the hose holder of FIG. 1, according to the invention;

FIG. 6 is a cross-sectional view of the hose holder of FIG. 1, taken along the 6-6 line indicated in FIGS. 3 and 4, according to the invention;

FIG. 7 is a perspective view of a ground-engaging support structure post for a hose holder, according to the invention;

FIG. 8 is a top view of a first embodiment of a peg on a post, according to the invention;

FIG. 9 is a side view of the peg and a cutaway portion of the post of FIG. 8A, according to the invention;

FIG. 10 is a short-sighted bottom view of a socket with a first embodiment of a socket hole, and a cross-section of the first embodiment of the peg which is mated with the socket, according to the invention;

FIG. 11 is a short-sighted bottom view of a socket with a second embodiment of a socket hole, and a cross-section of second embodiment of a peg which is mated with the socket, according to the invention;

FIG. 12 is an exploded side view of a holder and a multi-section embodiment of a post, according to the invention;

FIG. 13 is an exploded side view of a post embodiment having different joints than the post of FIG. 12, according to the invention; and

FIG. 14 is a side perspective view of an assembled post engaged with the ground and supporting a hose holder that is holding a hose with a spray nozzle in operation, according to the invention.

### DETAILED DESCRIPTION OF THE INVENTION

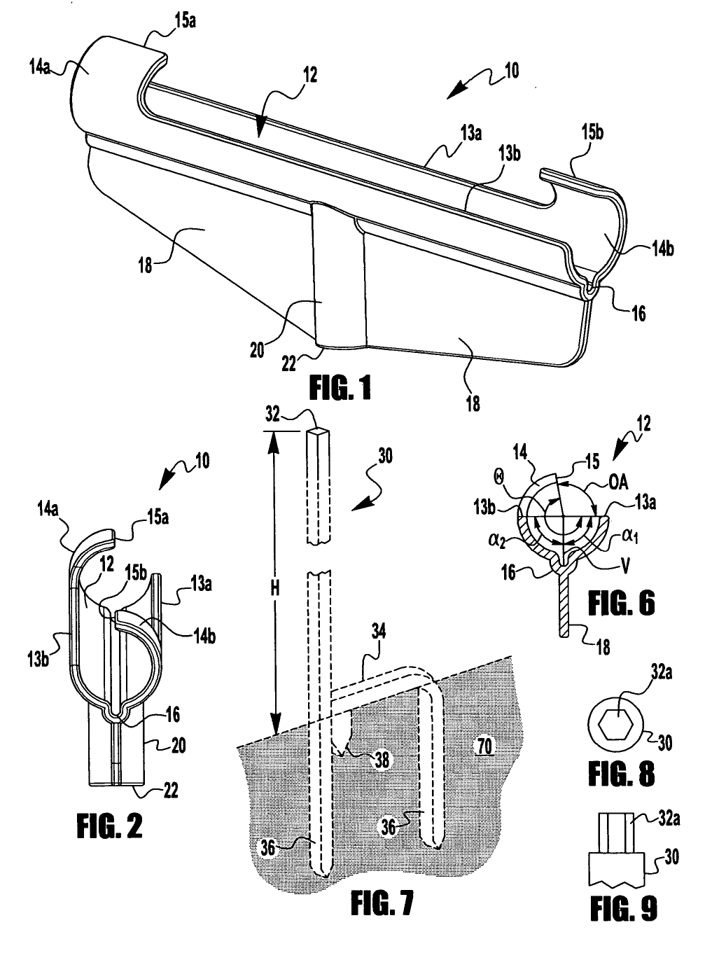

FIGS. 1-5 show various views of the elements of a preferred embodiment of an inventive holder 10 having a socket 20 that is designed to be used in cooperation with a removably matingly shaped peg 32 that can be mounted on any suitable support structure, such as a ground-engaging post 30 as shown in various exemplary embodiments in FIGS. 7, and 12-14. FIGS. 5, and 8-11 show exemplary embodiments of socket holes 24a, 24b (collectively referred to as socket holes 24) and corresponding removably matingly shaped pegs 32a, 32b (collectively referred to as pegs 32). FIG. 14 illustrates an example of usage of the hose holder 10 wherein a hose 60 is inserted in the hose holder 10 in a direction determinative of a selected elevational angle for direction of spray 64, and the holder 10 is set on (removably mated with) the peg 32 of an exemplary post 30 such that a desired horizontal angle is selected for the spray 64. Given the importance of the removably matingly shaped peg 32 for horizontal angular adjustment, a complete hose holder 11 is generally assumed to include a suitable peg 32, which also may be generally assumed to comprise the uppermost portion of a support structure of any suitable design such as the ground engaging post 30. Alternatively, the peg 32 is part of the holder 10, and the mating socket 20 is mounted on the uppermost portion of a support structure of any suitable design such as the ground engaging post 30.

Referring now to FIGS. 1-6, the preferred embodiment of the holder 10 comprises a longitudinally extending trough 12 that is attached at a fixed elevational angle β to a laterally extending socket 20. The trough 12 has a first trough edge 13a and a second trough edge 13b, both of which extend longitudinally between a first end clip 14a at one longitudinal end and a second end clip 14b at the opposed longitudinal end of the trough 12. The first and second end clips 14a, 14b are collectively referred to as end clips 14. The first end clip 14a preferably opens to one side of the holder 10, and the second end clip 14b preferably opens to a second side of the holder 10, opposite to the first side. Preferably a groove 16 extends longitudinally along the whole longitudinal length L of the trough 12, for draining water that may enter the trough 12. A web 18, for reinforcement and/or decoration, may also extend between the socket 20 and the trough 12. Preferably the groove 16 extends along the bottom of the trough 12, where the socket 20 and the web 18 are attached.

The trough 12 is designed to hold a hose 60 in a substantially linear configuration in the holder 10, i.e., not allowing the hose 60 to squirm, bend, or otherwise shift the hose position between the end clips 14. The end clips 14 are designed to hold the hose 60 in the trough 12, but are resilient such that the end clips 14 can be manually bent open enough to insert or remove the hose 60 into/out of the trough 12. Thus the inventive hose holder 10 removably holds a hose 60. The holder 10 is made out of any suitable semi-rigid resilient material, preferably a suitable molded plastic (e.g., PVC), and is preferably a single piece construction.

As best seen in the cross-sectional view of FIG. 6, the trough 12 is partially circular in shape, circling upward from the groove 16 on both sides. Given a vertical radius line V that marks the “bottom” of the trough 12 (preferably centered on the groove 16), then a first trough edge extent angle α1 is measured from the vertical radius line V to the first trough edge 13a, and a second trough edge extent angle α2 is measured from the vertical radius line V to the second trough edge 13b. Preferably, the first trough edge extent angle α1 is approximately equal to the second trough edge extent angle α2, each of which is preferably in the range of approximately 40° (degrees) to approximately 100°, more preferably in the range of approximately 60° to approximately 100°, and most preferably approximately 90°.

Similarly, each end clip 14 circles upward from the vertical radius line V (bottom of the trough 12), continuing the same circular contour as the trough 12, but preferably extending farther to a clip edge 15 (individually referred to as a first clip edge 15a and a second clip edge 15b). For each end clip 14, a clip extent angle θ is measured from the clip edge 15 around the trough 12 to the opposed trough edge 13. Thus the clip extent angle θ for the first end clip 14a is measured from the first clip edge 15a around the trough 12 to the opposed first trough edge 13a; and the clip extent angle θ for the second end clip 14b is measured from the second clip edge 15b around the trough 12 to the opposed second trough edge 13b. Preferably, the clip extent angle θ is in the range of approximately 240° to 280°, more preferably in the range of approximately 250° to 270°, and most preferably approximately 260°. In other words, an opening angle OA for the first end clip 14a is the angular extent of the open space between the first clip edge 15a and the opposed first trough edge 13a; and the opening angle OA for the second end clip 14b is the angular extent of the open space between the second clip edge 15b and the opposed second trough edge 13b. Preferably, the opening angle OA is in the range of approximately 80° to 120°, more preferably in the range of approximately 90° to 110°, and most preferably approximately 100°.

Several alternative embodiments are contemplated. For example, the end clips 14 could open on the same side of the holder 10. For example, the end clips 14 could open upwards, thus having two clip edges 15 for each end clip 14 such that each end clip 14 circles upward beyond both trough edges 13a and 13b. For example, either or preferably both of the trough edges 13 could circle upward until its/their trough edge(s) 13 become collinear with either or preferably both of the clip edge(s) 15. Preferably the latter alternative embodiment would result in the first trough edge extent angle α1 and the second trough edge extent angle α2 (not necessarily equal in magnitude to each other) each ranging between approximately 40° and approximately 240°, but restricted such that the total of the first trough edge extent angle α1 and the second trough edge extent angle α2 is equal to the clip extent angle θ, which is in the range of approximately 240° to 280°, more preferably in the range of approximately 250° to 270°, and most preferably approximately 260°. As a result, the opening angle OA would be measured in the open space between the first trough edge 14a and the opposed second trough edge 13b, and would have a uniform magnitude along the entire length of the trough 12. The opening angle OA would still be in the preferred range of approximately 80° to 120°, more preferably in the range of approximately 90° to 110°, and most preferably approximately 100°. The opening measured by the opening angle OA would be positioned within the range of approximately 40° to approximately 320° as measured in one direction from the vertical radius line V.

In order to properly support and direct the spray from typical garden hoses 60, the trough 12 preferably has a longitudinal trough length L in the range of 4″ to 12″ (inches), preferably approximately 7.5″ long. The circular inside diameter of the trough 12 is the approximate average of a range of hose outside diameters selected to be appropriate for use with a given model of hose holder 10. For example, the most common garden hose is nominally 5/8″ (inch) which is roughly the inside diameter. For a 5/8″ hose, the outside diameter depends upon the hose wall thickness which varies somewhat, but results in an average outside diameter of about 15/16″. Thus the circular inside diameter of the trough 12 for this example of a nominal 5/8″ hose is approximately 1″. Also in this example, the end clip 14 opening measured by the opening angle OA is approximately 7/8″. As illustrated, and as further described hereinabove, the end clips 14 have arbitrary longitudinal clip lengths LC (e.g., a first clip length LCa and a second clip length LCb), being anywhere from a relatively short portion of the trough length L to extending the entire length L of the trough 12. In the preferred embodiment, the first clip length LCa is approximately equal to the second clip length LCb, and is preferably approximately 0.5″ to 1.5″, most preferably approximately 1″.

The socket 20 is generally cylindrical on the outside but is hollow with an open end 22 opposite to where the socket 20 attaches to the bottom of the trough 12. A socket hole 24 having a regular polygonal cross-section about a socket axis A is formed in the open end 22. The holder has a baseline 91 that is perpendicular to the socket axis A, and the trough 12 has a longitudinally extending trough line 93. The fixed elevational (vertical) angle β of the trough 12 is measured between the baseline 91 and the trough line 93 and is preferably in the range of approximately 0° to approximately 30°, more preferably in the range of approximately 5° to approximately 20°, and most preferably approximately 10°. Since the trough 12 generally angles upward at the elevational angle β from the second end clip 14b to the first end clip 14a, therefore the first end clip 14a is at a high end of the holder 10 (becoming an upper end clip 14a), and the second end clip 14b is at a low end of the holder 10 (becoming a lower end clip 14b).

FIGS. 5, and 8-11 show exemplary embodiments of removably matingly shaped socket holes 24 and pegs 32. The socket hole 24 is a multi-point (vertex) cylindrical walled cavity having a regular polygonal internal cross-section with a uniform rotational angle φ having a minimum increment between successive vertices. Thus, when the socket 20 (and therefore the holder 10) is mated with a mating peg 32, there will be multiple horizontal angular positions for the holder 10, and successive positions will be spaced apart by the minimum increment of the rotational angle φ. Since the socket 20 and peg 32 are removably matingly shaped, the socket 20 can be easily un-mated, rotated, and re-mated with the peg 32, thereby allowing selection of a desired rotational angular position φ of the socket 20 with respect to the peg 32. A preferred magnitude for the minimum increment of the rotational angle φ is 30°, which is achieved with a twelve point socket hole 24b such as is often implemented in socket wrench sockets. The peg 32 can have any cross-sectional shape that mates with the socket 20. For example, the peg 32 can have the same number of points as the socket hole 24, e.g., a six-pointed hexagonal peg 32a mating with a hexagonal socket hole 24a. For the sake of convenience, availability, and/or simplified manufacturing, it is preferred to use a four-pointed (square) peg 32b for mating with a twelve point socket hole 24b. Many other variations should be apparent: for example a sixteen point spline-type peg 32 (not shown) mating with a sixteen or thirty-two point socket hole 24 (not shown); or for example, a two edged blade for the peg 32 (not shown) mating with any socket hole 24 having an even number of vertices.

The peg 32 can be mounted on the top of any suitable support structure. For example, several pegs 32 could be spaced along a fence rail (not shown), projecting upwards from various desired locations along a garden or yard fence. Preferably the peg 32 is mounted on a ground engaging post 30 that can be removably planted in the ground at selected locations within or around a yard or garden. Of course, multiple posts 30 can be used for a single hose holder 10 which can then be moved from one post 30 location to another. A simple, readily available, suitable ground engaging post 30 (such as is used for supporting bird feeders) is illustrated in FIG. 7, and is made from square metal rod stock. A spike 36 extends downward for engaging (planting) in the ground 70. For added stability, a laterally projecting foot 34 has another spike 36 and a flange 38, also for planting in the ground 70. A commercially available bird feeder post could be easily adapted for use as a hose holder post 30 by simply cutting the square rod off at a desired height H, making the top of the post 30 become the peg 32 (e.g., a square peg 32b).

FIGS. 8 and 9 illustrate a portion of another post 30 embodiment wherein a hexagonal peg 32a is mounted on a circular post 30 that happens to have a larger diameter than the diametrical extent of the peg 32a Such a post 30 will obviously limit the insertion depth of the peg 32a into a socket 20, but otherwise, the shape, size, etc. of the post 30 is irrelevant as long as the post 30 is able to stably position the peg 32 in a relatively vertical orientation, and is able to support a spraying hose 60 in a hose holder 10 that is mated with the peg 32.

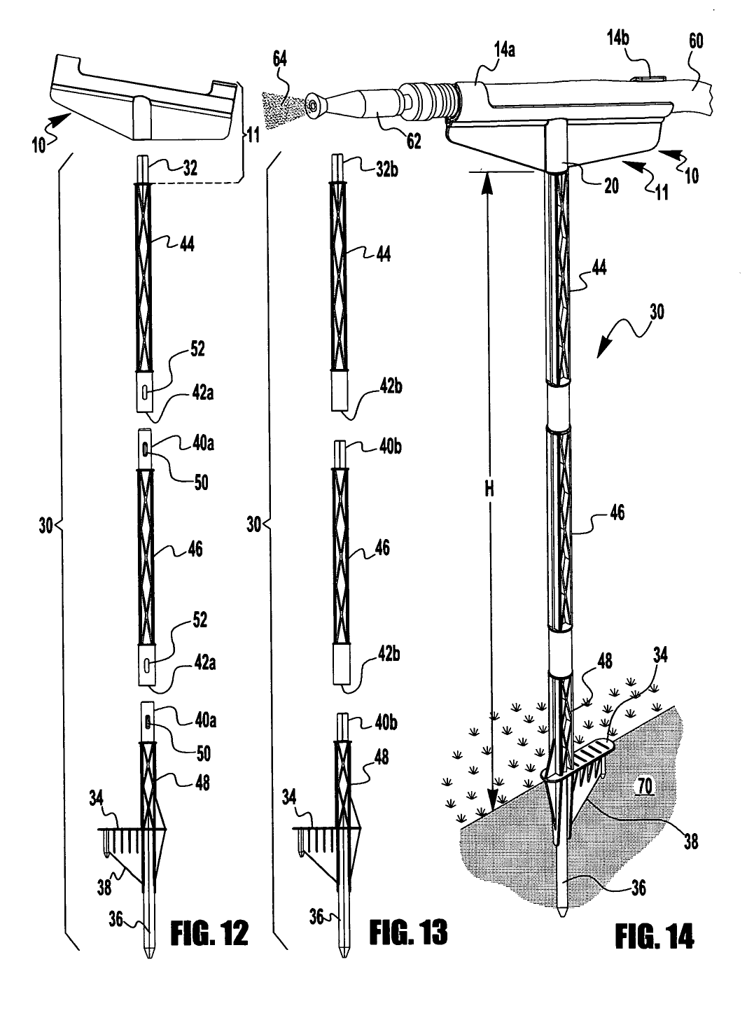

FIGS. 12-14 show sectional embodiments of a support structure that is a molded plastic post 30 having multiple post sections 44, 46, 48 for adjustment of height H, and for ease of storing, packaging and shipping. Referring first to FIG. 12, the complete hose holder 11 includes the holder 10 and the peg 32 which is mounted on (molded as a part of) a top post section 44. The post 30 includes the top post section 44, potentially multiple middle post sections 46 (one shown), and a ground engaging bottom post section 48, which has a spike 36 for planting in the ground, and preferably has a stabilizing foot 34 and flange 38. The post sections 44, 46, 48 are assembled using a male joint 40a on one end of a post section (e.g., middle post section 46, and bottom post section 48) that mates with a female joint 42a on an adjacent end of a post section (e.g., top post section 44, and middle post section 46). In the exemplary post 30 embodiment illustrated in FIG. 12, the male joints 40a are round cylinders and have at least one locking button 50 protruding laterally from the male joint 40a; and the female joints 42a are sockets having a corresponding cylindrical cavity designed for mating with the male joints 40a. At least one button hole 52 is cut into the female joint 42a for mating with the button 50. The button 50 and corresponding button hole 52 may be designed for either removable or permanent locking of a male joint 40a in a female joint 42a. The quantity of middle post sections 46 can be selected at the time of post assembly, thereby determining the height H of the assembled post 30 (see FIG. 14) which in turn determines the height H of a holder 10 placed on the pole 30.

FIG. 13 illustrates an alternate height adjustable embodiment of the pole 30, differing in that the male joints 40b have regular polygonal cross-sections (e.g., square, and duplicating the shape and dimensions of the exemplary square peg 32b), and the female joints 42b are multi-point sockets designed to mate with the male joints 40b (e.g., twelve point, and duplicating the shape and dimensions of the exemplary twelve point socket 24b). Of course it may be desirable to use dimensions that cause a tight mating fit of the polygonal male joint 40b and female joint 42b, thereby making it easier to carry and plant an assembled post 30. With this arrangement, the middle post section 46 can be identical to the top post section 44, and the holder height can be adjusted by mounting the holder 10 on top of the bottom post section 48, or on top of an assembly of any number of middle/top post sections 44/46 with the bottom post section 48. Furthermore, the polygonal male joints 40b and female joints 42b allow for added horizontal angular adjustment for the holder 10. For example, if the post sections 44, 46, 48 all have a square peg 32b (or an equivalent square male joint 40b), and if the polygonal female joints 42b are eight point sockets, but the holder socket 20 has a twelve point socket hole 24b, then 15 degree increments can be achieved in horizontal angular adjustment through appropriate positioning of both the holder 10 (30 degree increments) and the top or middle post sections 44, 46 (45 degree increments).

FIG. 14 illustrates an example of usage of the hose holder 10 with a post 30 embodiment (e.g., as illustrated unassembled in FIG. 13) which is an assembly of the top post section 44 plus one middle post section 46 plus the bottom post section 48, thereby selecting the height H of the hose holder 10 above the ground 70 into which the post 30 is planted by means of the ground engaging spike 36, foot 34, and flange 38. The holder height H can be adjusted by selecting a different combination and quantity of top/middle post sections 44/46. The holder height H can also be adjusted by setting the holder on a selected one of a plurality of different-height H support structures (e.g., posts 30).

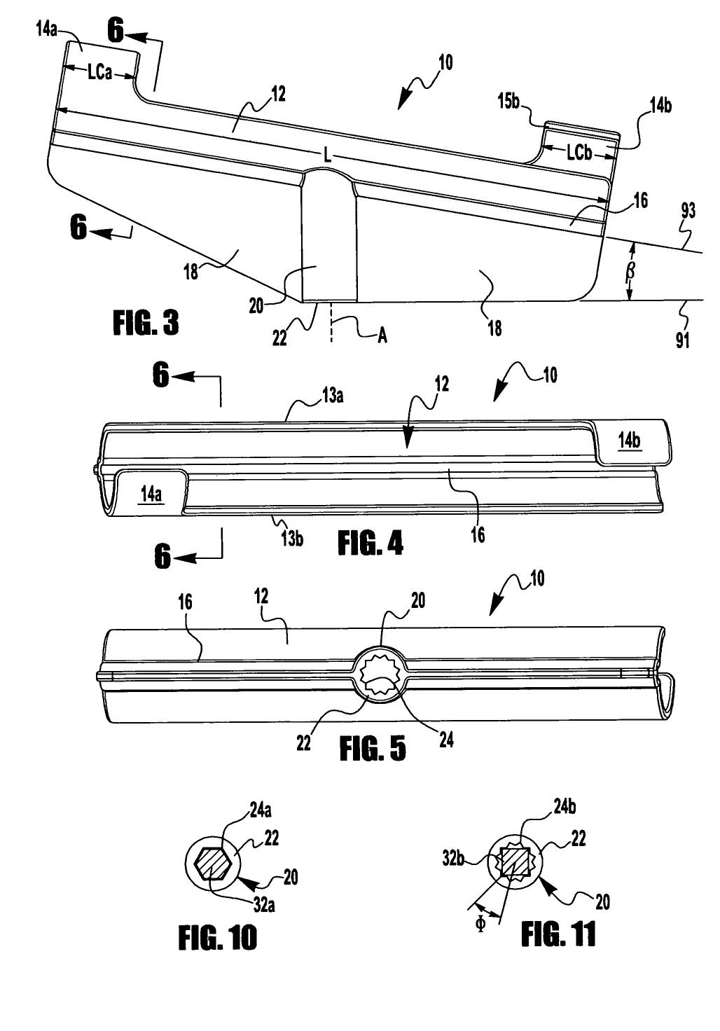

A hose 60 having a spray nozzle 62 at its open end is inserted in (engaged with) the hose holder 10 with the nozzle 62 adjacent to the upper (first) end clip 14a, thereby selecting an upward directed elevational angle β (shown in FIG. 3) for the direction of water spray 64 emanating from the nozzle 62. A downward directed elevational angle β can be selected simply by reversing the direction of the hose 60 when it is inserted in the hose holder 10 such that the nozzle 62 is adjacent to the lower (second) end clip 14b. For the purposes of this description, the open end of the hose is itself considered to be an embodiment of a spray nozzle 62.

The holder 10 is set on (mated with) the peg 32 (e.g., square peg 32b) of the post 30 such that a desired horizontal (rotational) angle φ (see FIG. 11) is selected for the spray 64. Horizontal angular adjustment of the holder 10 can be easily accomplished without needing to unplant and replant the ground engaging portion (e.g., bottom post section 48) of the post 30. The holder 10 can simply be lifted off the post 30, thereby un-mating the socket 20 and the peg 32, rotated to a new selected rotational angle φ, and replaced on the post 30, thereby mating the socket 20 and the peg 32 at the new selected rotational angle φ. As described above, additional adjustment may be possible by rotating post sections 44, 46, 48 relative to each other.

Further flexibility in positioning the hose holder 10 is easily achieved by unplanting and replanting the post 30, or preferably by planting a plurality of posts 30 at a plurality of selected locations in the yard or garden. The height H of each post 30 can be separately selected as desired. The holder 10 can be left attached to the hose 60 and then moved among the plurality of pre-planted posts 30, selecting one or more spraying directions (horizontal rotational angle φ and elevational angle β) at each post 30. Conveniently, the holder 10 is small enough that it can be left attached to the hose 60 when the hose 60 is coiled up and stored away.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

1. A hose holder comprising:
a longitudinally extending trough for holding a hose; and
a socket with a multi-point socket hole, wherein the socket extends laterally from a bottom of the trough.

2. The hose holder of claim 1, further comprising:
a peg shaped for adjustable mating with the socket.

3. The hose holder of claim 2, wherein:
the peg projects approximately upward from a ground engaging support structure.

4. The hose holder of claim 2, wherein:
the socket hole and the peg have regular polygonal cross-sections.

5. The hose holder of claim 2, wherein:
the socket hole has twelve points; and
the peg has four points.

6. The hose holder of claim 1, wherein:
the trough is attached at a fixed elevational angle to the socket, wherein the elevational angle is measured between a baseline that is perpendicular to a socket axis, and a longitudinally extending trough line.

7. The hose holder of claim 6, wherein:
the elevational angle is in the range of approximately 0 degrees to approximately 30 degrees.

8. The hose holder of claim 1, further comprising:
a partially circular cross-sectional shape for the trough;
a longitudinally extending first trough edge at a first trough edge extent angle measured in a first direction from the trough bottom; and
a longitudinally extending second trough edge at a second trough edge extent angle measured in a second direction, opposite to the first direction, from the trough bottom.

9. The hose holder of claim 8, wherein:
the first trough edge extent angle is approximately equal to the second trough edge extent angle; and
each of the first and second trough edge extent angles is within the range of approximately 40 degrees to approximately 100 degrees.

10. The hose holder of claim 8, wherein:
the sum of the first trough edge extent angle and the second trough edge extent angle is within the range of approximately 240 degrees to 280 degrees.

11. The hose holder of claim 8, further comprising:
a first end clip circling upward from the trough bottom, continuing the same circular contour as the trough, to a first clip edge protruding from a first one of the first and second trough edges, and extending longitudinally along a first portion of a trough length; and
a second end clip circling upward from the trough bottom, continuing the same circular contour as the trough, to a second clip edge protruding from a second one of the first and second trough edges, and extending longitudinally along a second portion of the trough length.

12. The hose holder of claim 11, wherein:
the first one trough edge is different than the second one trough edge; and
the first portion of the trough length and the second portion of the trough length are at opposed longitudinal ends of the trough.

13. The hose holder of claim 11, wherein:
each of the first and second trough edge extent angles is within the range of approximately 40 degrees to approximately 100 degrees; and
an opening angle, measured across open space between the first clip edge and its opposed trough edge is approximately equal to an opening angle measured across open space between the second clip edge and its opposed trough edge, and has a magnitude in the range of approximately 80 degrees to 120 degrees.

14. The hose holder of claim 1, further comprising:
a longitudinally extending groove in the bottom of the trough.

15. The hose holder of claim 1, further comprising:
single piece construction molded out of a resilient material.

16. The hose holder of claim 1, further comprising:
a web extending between the socket and the trough.

17. A method for adjusting the spray direction of a hose in a hose holder, the method comprising the steps of:
providing a removably matingly shaped socket and peg;
designating a one of the socket and peg as a first joint and the other one of the socket and peg as a second joint;
attaching the first joint to the holder as a lateral extension of the holder relative to the longitudinally extending hose in the holder;
attaching the second joint as an approximately vertical extension of a ground engaging support structure; and
adjusting a horizontal angular position of the holder by un-mating the first joint and the second joint; followed by rotating the holder to a new selected horizontal angle, followed by mating the first joint and the second joint at the new selected horizontal angle.

18. The method of claim 17, further comprising the steps of:
attaching the first joint to the holder at a fixed elevational angle, wherein the elevational angle is measured between a baseline that is perpendicular to a first joint axis, and a longitudinally extending line of the hose in the holder;
removably engaging the hose in the holder; and
adjusting an elevational angular position of the hose by selecting an upward directed elevational angle or a downward directed elevational angle, wherein:
the upward directed elevational angle is selected by engaging the hose in the holder such that a spraying end of the hose is adjacent to an upper end of the holder; and
the downward directed elevational angle is selected by engaging the hose in the holder such that the spraying end of the hose is adjacent to a lower end of the holder.

19. The method of claim 17, further comprising the step of:
adjusting a height of the holder above the ground by adjusting a height of the ground engaging support structure.

20. The method of claim 17, further comprising the step of:
holding the hose in a substantially linear configuration in the holder by providing a longitudinally extending trough in the holder, the trough having a partially circular cross-sectional shape dimensioned for partially encircling the hose.

21. The method of claim 17, further comprising the steps of:
providing one or more support structures that are engaged in the ground such that a plurality of second joints are positioned at a plurality of horizontal locations; and
adjusting a horizontal location of the hose by selecting a one of the plurality of second joints, and engaging the first joint with the selected one of the plurality of second joints.

22. The method of claim 17, further comprising the steps of:
dividing the support structure into a plurality of sections, including a ground engaging section and at least one non-ground-engaging section, wherein each non-ground-engaging section has a copy of the peg on one end, and a variant of the socket on an opposed end; such that the variant of the socket has a different number of points than the socket; and
providing smaller increments for horizontal angular position adjustment by horizontally rotating one of the at least one non-ground-engaging sections relative to the ground engaging section, in combination with horizontally rotating the holder relative to the one of the at least one non-ground-engaging sections.
